(19) United States
(12) Patent Application Publication
(10) Pub. No.: US 2011/0274607 A1
(43) Pub. Date: Nov. 10, 2011

(54) VANADIA-SUPPORTED ZEOLITES FOR SCR OF NO BY AMMONIA

(75) Inventors: Putluru Siva Sankar Reddy, Vedbaek (DK); Anders Riisager, Tastrup (DK); Rasmus Fehrmann, Kobenhavn O (DK)

(73) Assignee: TECHNICAL UNIVERSITY OF DENMARK, Kgs. Lyngby (DK)

(21) Appl. No.: 13/078,523

(22) Filed: Apr. 1, 2011

Related U.S. Application Data
(60) Provisional application No. 61/331,091, filed on May 4, 2010.

(51) Int. Cl. B01D 53/56; B01J 37/02; B01J 35/06; B01J 29/26; B01J 29/48; B01J 35/02; B01J 29/076; B01J 37/08

(52) U.S. Cl. 423/239.2; 502/87; 502/78; 502/77

(57) ABSTRACT

The catalytic behaviour of vanadia-supported zeolite catalysts with different SiO₂/Al₂O₃ ratios was tested for the SCR of NO with ammonia. The SCR activity was found to be directly correlated to the total acidity of the catalysts. On the surface of these zeolites the V₂O₅ was highly dispersed and amorphous in nature. After the impregnation with vanadium and subsequent poisoning with potassium oxide not much change in micro-pore structure of HZSM5 was observed by N₂ adsorption studies. Interestingly, potassium-doped HZSM5 and HMORDENITE catalysts showed high resistance to deactivation because of the unique nature of the material exhibiting higher surface area and acidity than the conventional V₂O₅—WOₓ/ZrO₂ or TiO₂ catalysts. Consequently, a possible application of these alkali-tolerant SCR catalysts in biomass fired power plants can be envisaged.

### FIELD OF THE INVENTION

The present invention concerns the selective removal of nitrogen oxides (NOx) from gasses. In particular, the invention concerns a process, a highly alkali metal resistant, vanadia-supported zeolite catalyst and the use of said catalyst for removal of NOx from exhaust or flue gases, said gases comprising alkali or earth alkali metals. Such gases comprise for example flue gases arising from the burning of biomass, combined biomass and fossil fuel, and from waste incineration units. The process comprises the selective catalytic reduction (SCR) of NOx, such as nitrogen dioxide (NO₂) and nitrogen oxide (NO) with ammonia (NH₃) or a nitrogen containing compound selected from ammonium salts, urea or a solid urea derivative as reductant.

### BACKGROUND OF THE INVENTION

Generally, nitrogen oxides are generated from stationary sources such as, e.g. industrial boilers, gas turbines, steam power plants, waste incinerators, marine engines, and petrochemical plants. The selective catalytic reduction (SCR) is considered a useful approach for removing nitrogen oxides generated from stationary sources in views of economic and technological efficiency. A wide number of catalysts have been reported for the effective removal of nitric oxide by ammonia as the reducing agent. All the catalysts can broadly be classified into three types namely noble metals, metal oxides and zeolites. Noble metals are very active for the reduction of NO_{N}, but not selective to N₂ because of ammonia oxidation. Accordingly, noble metal catalysts have been replaced by metal oxide catalysts for conventional SCR and zeolites for high temperature SCR applications because of their thermal stability. The industrial metal oxide catalysts for the commercial SCR process are based on TiO₂-supported V₂O₅—WO₃ and V₂O₅—MoO₃ oxides. The use of TiO₂ as a support is limited by the fact that TiO₂ has a low surface area, that it exists in several interconvertible crystalline forms (rutile, anatase and brookite+additional metastable forms) of which many have low activity as catalyst supports, and finally by its relative high cost. Most industrial SCR systems use vanadium-based catalysts which define an operating temperature range of 300 to 420° C. to obtain maximum NOₓ conversion efficiency.

At higher temperatures (above 420° C.) the oxidation of ammonia competes with the SCR reaction on vanadium-based catalysts ultimately forming nitrogen oxides. The loss of selectivity via ammonia oxidation is severe; actually so much that commercial use is limited to temperature applications below 420° C. Moreover, the temperature constraint limits the flexibility of the location of the SCR catalyst and adds additional costs for heat exchangers where the exhaust temperature exceeds this temperature limitation. These disadvantages are easily overcome by using zeolites as support materials.

SCR may thus be deemed a well-proven technology as regards its application with conventional, non-renewable fuels. However, over the past two decades there has been an increasing interest globally in the utilization of non-conventional fuels like biomass for energy production. Biomass such as wood and straw are CO₂ neutral fuels which may help to reduce the greenhouse effect. According to the latest official estimate, Denmark has approximately 165 PJ of residual biomass resources including waste, of which only half are currently used. Residual resources comprise straw, which is not needed for animal purposes, together with biogas from manure, organic waste and waste from wood industries. However, the potential of biomass fuels from a change of crops is huge. Denmark grows a lot of wheat which can be replaced by others crops such as corn, leading to a much higher biomass production while still maintaining the same output for food. Such reorganisation of the farming areas together with a few other options may lead to a total biomass fuel potential as high as 400 PJ.

In the EU so far two binding directives have been enacted [Directive 2001/77/EC on the promotion of electricity produced from renewable energy sources in the internal electricity market (2001) and Directive 2003/30/EC on the promotion of the use of biofuels or other renewable fuels for transport (2003)] which set quantitative targets for renewable energies and fuels in the current and future energy supply up to 2010 (Renewable electricity in 2010: EU 22%; Biofuels in 2010: 5.75%; Total renewable energy consumption in 2010: 12%). Until 2020 these targets are to be enlarged considerably [EU Renewable Energy Road Map—Renewable energies in the 21^{st} century: building a more sustainable future (2007)]. Given that nearly 66% of renewable energy production in the EU in 2004 was based on biomass (hereafter referred to as bioenergy), the demand for biomass will increase rapidly during this time horizon [Eurostat (2006) Energy, Transport and Environment Indicators].

The same trend is observed in the US, where biomass sources provide a small but growing percentage of all energy consumed. In 2002, biomass supplied about 47 percent of all renewable energy consumed in the United States. Electric generation from biomass (excluding municipal solid waste) represented about 11 percent of all generation from renewable sources in the United States. In fact, biomass supplied more energy to the US in 2002 than any other form of renewable energy, including hydroelectric power. Biomass supplied almost six times the energy of geothermal, solar and wind energy sources combined. Globally, biomass meets about 14 percent of the world's energy needs.

Thus, the worldwide use of biomass for production of energy is expected to keep an ascendant trend despite of its rather low caloric value. The main pollutants resulting from biofuels are nitrogen, chlorine, potassium and silicon, the main emission being NOx, which may be reduced significantly by applying SCR technology. However, even if SCR is a well-proven technology, its application with non-conventional fuels like biomass brings specific challenges. In particular, deactivation of the catalyst by biomass containing alkali metals and subsequent activity reduction is problematic. Flue gases stemming from the incineration of biomass fuel typically contain about 200-1000 mg KCl/Nm³ whereas incineration of coal only leads to ppm levels of KCl.

Several authors [A. L. Kustov et al., Appl. Catal. B 58 (2005) 97; J. Due-Hansen et al., J. Catal. 251 (2007) 459; J. Chen et al., J. Catal. 125 (1990) 411; L. Lisi et al., Appl. Catal. B 50 (2004) 251; L. Lietti et al., Appl. Catal. B3 (1993) 13] have reported the deactivation effect of alkaline metals on the activity of V₂O₅/TiO₂ catalysts. Most of them conclude that poisonous additives (e.g. potassium, barium) affect the Brønsted acid sites, which are responsible for the ammonia adsorption, thus decreasing both their number and activity in NO reduction. The relative decrease in catalytic activity after doping with potassium is well correlated with the decrease in total acidity of the catalysts.

Strategic approaches to overcome the alkali metal deactivation include use of highly acidic support materials and a high vanadium content to maintain a high number of active sites, thus making the catalyst less susceptible to deactivation by alkali metals. Vanadium-containing zeolites have already found considerable interest due to their catalytic properties (acidity and high surface area) in a variety of reactions including the SCR reaction [G. Piehl et al. Catal. Today 54 (1999) 401; M. Mark et al., J. Catal. 175 (1998) 48; A. Lavat et al. Mater. Lett. 59 (2005) 2986; R. C. Adams et al. Catal. Today 33 (1997) 263; S. M. Jung et al., O. Demoulin et al. J. Mol. Catal. A 236 (2005) 94.]. Acidity and surface area of the zeolites are easily tunable with maximum values observed with compositions corresponding to SiO₂/Al₂O₃ ratios of 10-25. Acidity is required to host the poisonous alkali metals, whereas a high surface area is needed to allow a high V₂O₅ content, without forming crystalline phases with high capability of ammonia oxidation.

Pence and Thomas [D. T. Pence et al., Proceedings of the AEC Pollution Control Conference, CONF-721030 (1972) 115] first documented H-mordenite with vanadia as an active catalyst for the selective reduction of NOₓ to N₂ using NH₃ as a reducing agent and thus created interest in the use of zeolites as SCR catalysts. Concurrently, Seiyama and co-workers [T. Seiyama et al. Chem. Lett. (1975) 781] investigated the SCR activity of various transition metal ion-exchanged Y zeolite catalysts. Promising results obtained here led to a variety of later studies focusing on the enhancement in SCR activity by exchanging metals (e.g., Fe, Cu, Ni, Pt, Rh, Co, Ga, etc.) into different zeolites (e.g., Y, mordenite, ZSM5, ferrierite, beta zeolites). Based upon these studies, it is evident that proper selection of metals exchanged into appropriate zeolites can greatly enhance the activity of SCR catalysts. It is interesting to note, however, that the SCR activity and selectivity of these same metals is low if the metals are not exchanged into appropriate zeolites.

In the present work, the effect of SiO₂/Al₂O₃ ratio of zeolite support materials and further the V₂O₅ content were optimized on various zeolite supports for achieving high activity in the SCR reaction. The influence of potassium oxide additives on the activity was also studied and compared with traditional SCR catalysts. All the catalysts were characterized by various techniques to allow detailed discussion of the compositional effects on the SCR performance.

U.S. Pat. No. 7,264,785 mentions a catalyst system for Internal Combustion Engines (i.e. non-stationary) comprising different metals supported on a zeolite for use in Selective Catalytic Reduction (SCR) of NOx by ammonia. Only the metals Cu, Ce, Fe and Pt are specifically mentioned as suitable. The reference also mentions SCR of NOx in exhaust gases by ammonia, but only achieves about 50-65% total conversion of NOx. The role of the zeolite is to absorb humidity and to catalyze the conversion of ammonia precursors such as urea to ammonia. Other references mention zeolitic catalyst systems which are impregnated/exchanged with metal/metal ions, eg. U.S. Pat. No. 6,528,031 B1 which only discusses noble metals, US 2008/0127638 A1 which only discusses platinum group metals, U.S. Pat. No. 7,005,116 B2 which only discusses the use of transition metals and mention that vanadium is preferably avoided. MORDENITE is not found to be a suitable zeolite either, U.S. Pat. No. 5,059,569 A1 which discusses Cu, V, W, Fe, Co and Mo on zeolites with a SiO₂/Al₂O₃ ratio of 4-6, US 2007/0134146 A1 which is directed to copper-on-Y-zeolite catalysts with a typical loading of about 5% metal oxide. Vanadium is mentioned as a non-exemplified alternative, U.S. Pat. No. 5,260,043 A1 which only discusses Co, Ni, Fe, Cr, Rh, Mn and not V. US 2010/0075834 A1 discloses a preparation of metal-doped zeolites by grinding a dry mixture of a zeolite with a compound of a catalytically active metal, followed by heating the mixture in a reactor. The obtained catalyst can be used in SCR deNOx reactions. Cu, Co, Rh, Pd, Ir, Pt, Ru, Fe, Ni, and V are mentioned, only a Fe based catalyst is exemplified.

None of these references mention Vanadium as the preferred catalytic metal, and none mention the selective catalytic reduction of NOx in exhaust or flue gases obtained from burning biomass. Also, no reference discusses the problem of alkali metals being present in exhaust gases released on burning biomass, which will normally lead to fast and irreversible poisoning of standard commercial SCR deNOx catalysts.

There is consequently still a need for developing SCR catalysts which may function well under the specific and very demanding conditions of biomass incineration, and the same time be sufficiently robust to allow for uninterrupted performance over long time periods.

### SUMMARY OF THE INVENTION

The first aspect of the present invention concerns the use of a zeolite catalyst in the selective removal of nitrogen oxides from gases containing a significant amount of alkali metal and/or alkali earth compounds, which catalyst comprises:
a. a zeolite support with a SiO₂/Al₂O₃ ratio lower than 40
b. 8% w/w or more V₂O₅
   which removal takes place in the presence of a nitrogen containing compound selected from ammonia, ammonium salts, urea or a solid urea derivative.

The second aspect of the invention concerns a method for providing a zeolite catalyst, comprising the steps of:
a) calcining the ammonium form of the zeolite support at about 550° C. for about 5 hours to obtain the acidic, H-form of the zeolite,
b) impregnating the calcined zeolite support with a vanadia precursor,
c) drying the impregnated zeolite catalyst at about 120° C. for about 12 hours followed by calcination at 500° C. for about 4 hours.
   wherein said zeolite support has a SiO₂/Al₂O₃ ratio lower than 40, and wherein said catalyst comprises 8% w/w V₂O₅ or more, such as, for example, 8-16%; 9-14%, 10-12% or around 12% w/w V₂O₅.

The third aspect of the invention concerns a process for the selective removal of nitrogen oxides with a nitrogen containing compound selected from ammonia, ammonium salts, urea or a solid urea derivative from gases resulting from the burning of biomass, combined biomass-fossil fuel, or emerging from stationary waste incineration units, which process comprises using a catalyst obtainable by the method of the second aspect of the invention.

### FIGURES

FIG. 1

NH₃-TPD profiles of V₂O₅/HZSM5 catalysts with different SiO₂/Al₂O₃ ratios.

FIG. 2

Catalytic activity profiles of V₂O₅/HZSM5 catalysts with different SiO₂/Al₂O₃ ratios under dry conditions.

FIG. 3

Catalytic activity profiles of various zeolites with different V₂O₅ content under dry conditions.

FIG. 4

XRD patterns of undoped and potassium-doped catalysts with optimum V₂O₅ content.

FIG. 5

Catalytic activity profiles of undoped and potassium-doped catalysts with optimum V₂O₅ content under wet conditions.

FIG. 6

NO conversion and N₂O formation for zeolite catalysts with optimum V₂O₅ content on zeolites at 500° C. under dry and wet conditions.

### DETAILED DESCRIPTION OF THE INVENTION

The first aspect of the present invention concerns the use of a zeolite catalyst in the selective removal of nitrogen oxides from gases containing a significant amount of alkali metal and/or alkali earth compounds, which catalyst comprises:
a. a zeolite support with a SiO₂/Al₂O₃ ratio lower than 40
b. 8% w/w or more V₂O₅
   which removal takes place in the presence of a nitrogen containing compound selected from ammonia, ammonium salts, urea or a solid urea derivative.

In one embodiment the zeolite has a SiO₂/Al₂O₃ ratio lower than 40. In another embodiment the zeolite has a SiO₂/Al₂O₃ ratio of 25 or lower. In another embodiment the zeolite has a SiO₂/Al₂O₃ ratio between 10 and 25. In another embodiment the zeolite has a SiO₂/Al₂O₃ ratio of 15 or lower. In preferred embodiments the zeolite has a SiO₂/Al₂O₃ ratio selected from 15, 12 or 10.

In a further embodiment the zeolite is selected from HZSM5, HMORDENITE, HBETA and HY. In a preferred embodiment the zeolite is selected from HZSM5 and HMORDENITE. In a particularly preferred embodiment the zeolite is HMORDENITE.

The zeolite support is preferably impregnated with a vanadia precursor to achieve a final loading of between 8 and 16% w/w V₂O₅ after calcination.

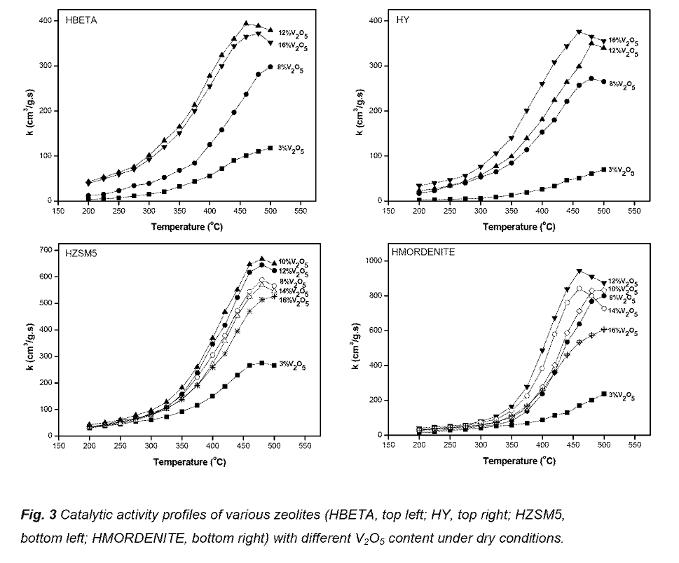

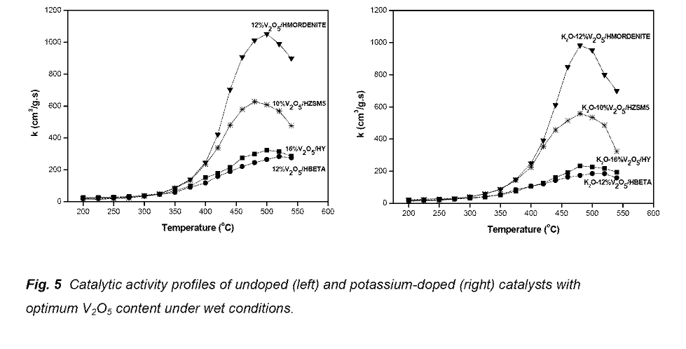

Precipitating vanadia on zeolites as disclosed in the present application has the technical effect that it allows a high loading of up to 12-16% w/w vanadia without exceeding monolayer coverage of V₂O₅ in contrast to typical (non-zeolitic) industrial catalysts, which can only accommodate 3-5 wt %. The thus obtained catalysts showed remarkable SCR activity (as measured by the rate constant for the SCR process) with a maximum reached at 12 wt % vanadia, cf. FIGS. 3 and 5. Exceeding the monolayer capacity of the carrier with a high vanadia loading leads to formation of crystalline V₂O₅ which exhibits decreased deNOx activity and increased ability to oxidize NH₃ and possibly also SO₂ in the flue gas (Busca et al., Appl. Catal. 18 (1998)).

In a preferred embodiment the calcined zeolite catalyst contains between 8 and 16% w/w V₂O₅. In an even more preferred embodiment the calcined zeolite catalyst contains between 9 and 14% w/w V₂O₅, or between 10 and 12% w/w V₂O₅, such as 10%, 12% or 14% w/w V₂O₅. In a particularly preferred embodiment the calcined zeolite catalyst contains 12% w/w V₂O₅.

In a preferred embodiment the zeolite catalyst comprises 12% V₂O₅ w/w on the HMORDENITE zeolite support.

In a specific embodiment the zeolite SCR catalyst is impregnated with potassium to achieve a final loading of about 100 μmol K (as potassium oxide, K₂O) per gr catalyst after calcination. In another embodiment the potassium doped catalyst is based on a HZSM5 or HMORDENITE zeolite support. In a further embodiment the potassium doped catalyst is based on a HMORDENITE zeolite support. In another embodiment, the potassium doped catalyst is K₂O-12% V₂O₅/HMORDENITE.

Ammonia is commonly used for the reduction of nitrogen oxides to nitrogen and water by the zeolitic catalysts of the invention, but solid “ammonia-like” materials like ammonium salts, urea and urea derivatives which may be converted to ammonia under the reaction conditions for the selective removal of nitrogen oxides from gases, may be economically viable and less hazardous alternatives to ammonia. Thus, in one embodiment of the invention the selective removal of nitrogen oxides takes place in the presence of an ammonium salt. In another embodiment the selective removal of nitrogen oxides takes place in the presence of urea or a urea derivative. In a preferred embodiment the selective removal of nitrogen oxides takes place in the presence of ammonia.

The catalysts of the present invention display a useful activity over a very wide temperature range. Thus, in one embodiment, the selective removal of nitrogen oxides takes place at a temperature between 275 and 550° C. In a preferred embodiment the selective removal of nitrogen oxides takes place between 320 and 400° C., which is suitable for most traditional stationary incineration plants having been designed for traditional SCR catalysts. In another embodiment the selective removal of nitrogen oxides takes place in equipment suited for higher temperatures between 460 and 480° C., at which temperature the catalysts of the present invention have their highest activity. However, as can be seen from FIGS. 3 and 5, very high rate constants were observed already at lower temperatures.

In an embodiment the invention also provides the use of a zeolite catalyst of the invention which comprises 8-16%; 9-14%, 10-12% or around 12% w/w V₂O₅. In a further embodiment the invention also provides the use of a zeolite catalyst of the invention wherein the zeolite has a SiO₂/Al₂O₃ ratio of between 10 and 25. In another embodiment the invention provides the use of a zeolite catalyst of the invention wherein the zeolite support is selected from HMORDENITE, HZSM5, HBETA and HY. In a different embodiment, the invention also provides the use of a zeolite catalyst of the invention wherein the selective removal of nitrogen oxides takes place in the presence of ammonia or urea, and at a reaction temperature from about 300 to about 500° C.

The second aspect of the invention concerns a method for providing a zeolite catalyst, comprising the steps of:
a) calcining the ammonium form of the zeolite support at about 550° C. for about 5 hours to obtain the acidic, H-form of the zeolite,
b) impregnating the calcined zeolite support with a vanadia precursor,
c) drying the impregnated zeolite catalyst at about 120° C. for about 12 hours followed by calcination at 500° C. for about 4 hours.
   wherein said zeolite support has a SiO₂/Al₂O₃ ratio lower than 40, and wherein said catalyst comprises 8% w/w V₂O₅ or more, such as, for example, 8-16%; 9-14%, 10-12% or around 12% w/w V₂O₅.

In a specific embodiment the invention provides a catalyst which is obtainable by the method of the second aspect of the present invention.

The vanadia precursor is conveniently chosen from ammonium vanadate, vanadium oxalate or another aqueously soluble vanadium compound known to the skilled person.

In a further embodiment the zeolite catalysts obtained by the method of the second aspect have a light-off temperature (i.e. the temperature at which a catalytic converter achieves a 50% conversion rate) around 300° C. under dry conditions, i.e. when the selective removal of nitrogen oxides from gases is carried out with gases containing little or no moisture. In another embodiment the zeolite catalysts obtained by the method of the second aspect have a light-off temperature around 350° C. under wet conditions, i.e. when the selective removal of nitrogen oxides from gases is carried out with gases containing moisture, which is the typical situation for gases resulting from the incineration of biomass.

In a further embodiment of the invention the zeolite catalysts obtained by the method of the second aspect have micropore volumes of between 0.09 and 0.24 cm³/g. In a preferred embodiment the zeolite catalysts have micropore volumes of between 0.1 and 0.15 cm³/g.

In a preferred embodiment of the invention, the zeolite catalysts obtained by the method of the second aspect of the present invention have a large surface area and a high total acidity.

The third aspect of the invention concerns a process for the selective removal of nitrogen oxides with a nitrogen containing compound selected from ammonia, ammonium salts, urea or a solid urea derivative from gases resulting from the burning of biomass, combined biomass-fossil fuel, or emerging from stationary waste incineration units, which process comprises using a catalyst obtainable by the method of the second aspect of the invention.

Among all the examined supports 12% V₂O₅/HMORDENITE showed the highest catalytic activity followed by 10% V₂O₅/HZSM5, 12% V₂O₅/HBETA and 16% V₂O₅/HY. 12% V₂O₅/HMORDENITE catalysts showed a maximum rate constant value of 944 cm³/g·s, whereas 10% V₂O₅/HZSM5, 12% V₂O₅/HBETA and 16% V₂O₅/HY catalysts showed maximum rate constant values of 667, 394 and 376 cm³/g·s, respectively.

All the optimum catalysts showed maximum catalytic activity at 460° C. except the 10% V₂O₅/HZSM5 catalyst, which showed maximum activity at 480° C. and the light-off temperature for this series of catalysts was around 300° C., as also found for the HZSM5 catalysts.

It was surprisingly found that the catalytic activity of the zeolite catalysts obtained by the method of the second aspect of the present invention can be maintained even when the catalyst is exposed to moisture. Thus, the catalytic activity under wet conditions of the 12% V₂O₅/HMORDENITE (1052 cm³/g·s) catalyst was much higher than that of commercial V₂O₅—WO₃/TiO₂ catalyst activity (500 cm³/g·s) reported in the literature [J. Due-Hansen et al. Appl. Catal. B 66 (2006) 161] under similar reaction conditions.

Thus, in another preferred embodiment the invention provides catalysts having a maximum rate constant value of over 600 cm³/g·s at between 460-480° C. and a light-off temperature around 300° C., and, in a further embodiment, the invention concerns a process for the selective removal of nitrogen oxides with a nitrogen containing compound selected from ammonia, ammonium salts, urea or a solid urea derivative from gases resulting from the burning of biomass, combined biomass-fossil fuel, or emerging from stationary waste incineration units, which gases contain significant amounts of moisture, typically between 2-20% H₂O or between 10-15% H₂O, which process comprises using a catalyst obtainable by the method of the second aspect of the invention.

It was furthermore surprisingly found that the zeolite catalysts obtained by the method of the second aspect of the present invention show high poisoning resistivity after doping with potassium oxide (100 μmol/g) and therefore are capable of maintaining a high catalytic activity even when exposed to gases containing significant amounts of alkali metal and/or alkali earth compounds. The poisoning resistance is believed to be due to a unique combination of high surface area, acidity and micropore structure of the zeolite support.

Accordingly, a further embodiment of the invention concerns a process for the selective removal of nitrogen oxides with a nitrogen containing compound selected from ammonia, ammonium salts, urea or a solid urea derivative from gases resulting from the burning of biomass, combined biomass-fossil fuel, or emerging from stationary waste incineration units, which gases contain significant amounts of alkali metal and/or alkali earth compounds, such as, for example, up to several hundred mg potassium per m³ gas, which process comprises using a catalyst obtainable by the method of the second aspect of the invention.

In the context of the present invention, the terms “around”, “about”, or “approximately” are used interchangeably and refer to the claimed value, and may include variations as large as +/−0.1%, +/−1%, or +/−10%. Especially in the case of log₁₀ intervals, the variations may be larger and include the claimed value +/−50%, or 100%. The terms “around”, “about”, or “approximately” may also reflect the degree of uncertainty and/or variation that is common and/or generally accepted in the art.

According to one embodiment of the invention, the catalyst according to the invention is provided in a form that provides minimal resistance to the flue gases, such as minimal pressure loss, while still providing reliable catalytic conversion of NOx to N₂. Generally, shapes, dimensions and designs of such a catalyst are known in the art.

The catalyst can for example be shaped as a monolith, extrudate, bead, plate, sheet or fibrous cloth, where the active phases can be introduced to the conformed material either by wash-coating, extrusion or spray painting, methods that are generally well-established in the art.

One embodiment of the invention concerns a process of selectively removing nitrogen oxides with ammonia from gases resulting from the burning of biomass, combined biomass-fossil fuel or emerging from waste incineration units at a temperature from about 150° C. to about 550° C., which process comprises using a catalyst obtainable by the method of the second aspect of the invention.

Commonly, for low temperature applications, such as placement of the catalyst unit in the flue gas duct after dust filtration in waste incineration plants, the temperature of the flue gas is in the range of 150-300° C. In the case of high temperature applications, such as placement of the catalyst unit at high dust positions in the flue gas duct, the temperature of the flue gas is often in the range of 340-420° C. For intermediate temperature applications, the temperature of the flue gas is in the area of about 250-370° C. The catalysts of the present invention can be placed at high dust positions in the flue gas duct due to their superior alkali metal poisoning resistivity, which allows them to catalyze the deNOx reaction with a much higher rate constant than if they were placed after a dust filter where the temperature is lower.

Commonly, one or more heat exchange units are provided in order to utilize the thermal energy of the flue gas. In one embodiment, the SCR process according to the invention takes place before a heat exchange unit. In a further embodiment, the SCR process is conducted after a heat exchange unit. In yet another embodiment, the SCR process takes place in between heat exchange units. In still another embodiment, heat controlling means are provided in order to control the temperature of the flue gas before and/or during the SCR. Thereby the efficiency of the SCR process can be controlled and/or optimized for the respective catalyst according to the invention, and its temperature profile with respect to catalytic activity. Such heat controlling means may comprise means to alter the rate of combustion, means to alter the flow of gas and the like. Generally, such means are well-known in the art.

Very often, fuels containing alkali metals as well as earth alkali will also contain significant amounts of alkali metals as well as earth alkali in the resulting flue gases upon incineration or burning. Fossil fuels, such as oil, natural gas and coal contain lower amounts of alkali metals and earth alkali metals. Waste, such as waste burned in waste incineration plants contains high levels of alkali metals as well as earth alkali metals. Biomass or biomass fuel such as straw, woodchips and wood pellets contain very high levels of alkali metals, especially K, as well as earth alkali metals. In the case of fly ash from burning straw, alkali metals and earth alkali metals can comprise as much as half of the total weight of the fly ash. Flue gases stemming from the incineration of biomass fuel typically contain about 200-1000 mg KCl/Nm³, whereas incineration of coal only leads to ppm levels of KCl.

By the use of a catalyst according to the invention, the lifetime can be increased significantly compared to conventional, non-zeolitic catalysts. In one embodiment of the invention, the life time of the catalyst is increased by a factor of at least 1.5; 1.5-3.0; 3.0-5.0; 5.0-10; or 100, compared to a similar/comparable catalyst without zeolitic support. In a further embodiment of the invention, the lifetime of the catalyst according to the invention is 2-5 times compared to a comparable catalyst without zeolitic support. Apart from economical benefits, this also provides a greater flexibility with respect to exchange and/or cleaning of the catalyst. By a larger window of opportunity for when to close the plant for exchange, cleaning, or reactivation of the catalyst, sensitive time periods may be avoided. For many applications, a shut down during summer is less expensive than during winter.

A catalyst according to the present invention can be treated and handled using conventional methods and techniques in the field. The catalyst can also be cleaned/washed and recycled.

The present invention will be better understood after reading the following non-limiting examples.

### Experimental

### Catalyst Preparation and Characterization

Commercial NH₄—ZSM5, NH₄-BETA, NH₄-Mordenite and NH₄—Y (Zeolyst International, USA) zeolites with different SiO₂/Al₂O₃ ratios were initially calcined at 550° C. for 5 h to obtain the H-ZSM5, H-BETA, H-Mordenite and H—Y supports, respectively. V₂O₅-zeolite catalyst with 3 to 16 wt. % V₂O₅ were prepared by wet impregnation of the supports with 0.5 to 1.25 M vanadia oxalate solution. After catalytic activity measurements the best catalysts were poisoned by impregnating with a 0.05 M solution of KNO₃ (Aldrich, 99.999%) to obtain a potassium loading of 100 μmol/g. Each impregnated catalyst was oven dried at 120° C. for 12 h followed by calcination at 500° C. for 4 h prior to use.

X-ray powder diffraction (XRPD) measurements were performed on a Philips PW 1820/3711 powder diffractometer using Ni-filtered Cu K_{α} radiation (λ1=1.5406 Å/1.5443 Å) within a 2θ range of 10-60° in steps of 0.02°. BET surface area and micropore volume of the sample were determined from nitrogen physisorption measurements on about 100 mg sample at liquid nitrogen temperature (77 K) with a Micromeritics ASAP 2010 instrument. The samples were heated to 200° C. for 1 h prior to measurement.

NH₃-TPD experiments were conducted on a Micromeritics Autochem-II instrument. In a typical TPD experiment, about 100 mg of dried sample was placed in a quartz tube and pretreated in flowing He at 500° C. for 2 h. Then, the temperature was lowered to 100° C. and the sample was treated with anhydrous NH₃ gas (Air Liquide, 5% NH₃ in He). After NH₃ adsorption, the sample was flushed with He (50 ml/min) for 100 min at 100° C. Finally, the TPD operation was carried out by heating the sample from 100 to 650° C. (10° C./min) under a flow of He (25 ml/min).

### Catalytic Activity Measurements

The SCR activity measurements were carried out at atmospheric pressure in a fixed-bed quartz reactor loaded with 50 mg of fractionized (180-300 μm) catalyst samples positioned between two layers of inert quartz. The reactant gas composition was adjusted to 1000 ppm NO, 1100 ppm NH₃, 3.5% O₂ and balance He for dry conditions and additional 2.3% H₂O for wet conditions (gas passed through a humidifier at room temperature) by mixing 1% NO/He (±0.1% abs.), 1% NH₃/He (0.005% abs.), O₂ (≦99.95%) and balance He (≦99.999%) (Air Liquide) using Bronkhorst EL-Flow F-201C/D mass-flow controllers. The total flow rate was maintained at 300 ml/min (ambient conditions).

During the experiments the temperature was raised stepwise from 200 to 540° C. while the NO and NH₃ concentrations were continuously monitored by Thermo Electron's Model 10A chemiluminiscent NO—NOₓ gas analyzer. At each set-temperature the N₂O concentration was further measured by gas chromatography (Shimadzu-14B GC, TCD detection, Poraplot column) after ensuring steady state conditions by maintaining the temperature for at least 30 min.

The catalytic activity is represented as the first-order rate constant (cm³/g·s), since the SCR reaction is known to be first-order with respect to NO under stoichiometric NH₃ conditions. The first-order rate constants were obtained from the conversion of NO as:

k=−(F_{NO})/(m_{cat}×C_{NO}))ln(1−X)

where F_{NO} denotes the molar feed rate of NO (mol/s), m_{cat} the catalyst weight, C_{NO} the NO concentration (mol/cm³) in the inlet gas and X the fractional conversion of NO.

### Results and Discussion

The results of the N₂-BET surface area, surface density of V₂O₅ and micropore volume measurements are summarized in Table 1 for V₂O₅/HZSM5 catalysts with various SiO₂/Al₂O₃ ratios. Increased SiO₂/Al₂O₃ ratio (from 15 to 140) of the V₂O₅/HZSM5 catalysts resulted in an increase of the total surface area (from 370 to 410 m²/g) and slight decrease in surface density (from 0.45 to 0.40 μmol V₂O₅/m²) whereas the micropore volume values remained unchanged and similar as found for other zeolites.

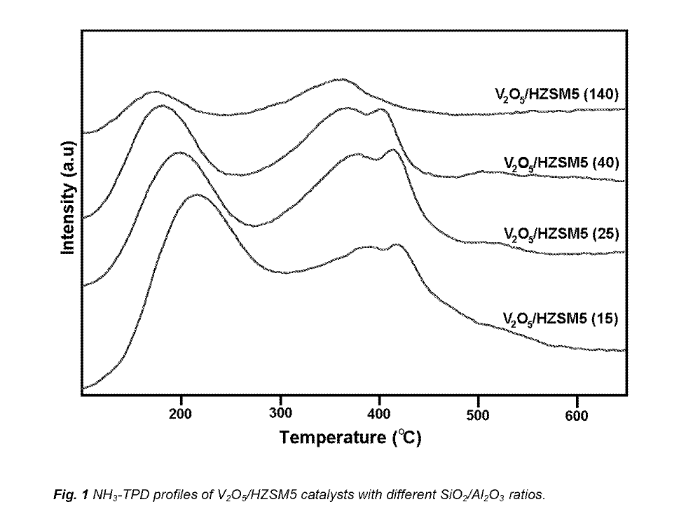

Temperature-programmed desorption (TPD) of ammonia or pyridine is a frequently used method for determining the surface acidity of solid catalysts as well as acid strength distribution. Ammonia is often applied as a probe molecule because of its small molecular size, stability and high basic strength (pKa=9.2) [A. Satsuma et al., Appl. Catal. A 194 (2000) 253]. In the present investigation, the acidity measurements have been carried out by the NH₃-TPD method. FIG. 1 shows NH₃-TPD profiles of 3% V₂O₅/HZSM5 catalysts in the temperature range of 100-650° C.

The results of the NH₃-TPD are summarized in Table 1.

TABLE 1
Surface area, pore volume and NH₃-TPD characterization
results of 3%V₂O₅/HZSM5 catalysts.

| | | Surface | | | | |
|---|---|---|---|---|---|---|
| Catalyst with | Surface | density | Micropore | Total | | |
| below SiO₂/ | area | (μmol | volume | Acidity | Tₘₐₓ1 | Tₘₐₓ2 |
| Al₂O₃ ratio: | (m²/g) | V₂O₅/m²) | (cm³/g) | (μmol/g) | (° C.) | (° C.) |
| 15 | 370 | 0.45 | 0.11 | 292 | 216 | 421 |
| 25 | 374 | 0.44 | 0.11 | 165 | 198 | 414 |
| 40 | 386 | 0.43 | 0.11 | 106 | 180 | 400 |
| 140 | 410 | 0.40 | 0.11 | 19 | 176 | 365 |

The acidity of the pure HZSM5 support (commonly between 700-1000 μmol/g depending on SiO₂/Al₂O₃ ratio) decreased with addition of vanadium oxide, probably due to presence of highly dispersed vanadyl ions at the acid surface sites of the support, thus making them unavailable for ammonia adsorption. Hence, especially V₂O₅/HZSM5 (SiO₂/Al₂O₃ ratio=140) exhibited a very small peak intensity in the NH₃-TPD measurement compared to the other V₂O₅/HZSM5 catalysts. Generally, the catalysts showed two ammonia desorption regions; one due to moderate acid strength (high Tₘₐₓ2 region) and the other due to weak acid strength (low Tₘₐₓ1 region). The Tₘₐₓ1 peak attributed to the weakly acidic sites was observed at around 200° C., while the Tₘₐₓ2 peak attributed to the strongly acidic sites was observed around 400° C. The V₂O₅/HZSM5 (SiO₂/Al₂O₃ ratio=15) catalyst with the highest content of aluminium revealed very large Tₘₐₓ1 and Tₘₐₓ2 peaks, indicating its high acid site density. The proportion of weakly acidic sites was further reduced compared to that of strongly acidic sites. An increase in the SiO₂/Al₂O₃ ratio of the V₂O₅/HZSM5 catalysts resulted in a significant decrease in intensity of both the Tₘₐₓ1 and Tₘₐₓ2 peaks. The temperature at the maximum of the desorption peaks was also shifted slightly towards a lower temperature with increasing SiO₂/Al₂O₃ ratio of the catalysts. This gradual shift of the maximum temperature may be due to a decrease in the acid site density, which hamper the re-adsorption of ammonia on the acidic sites in the pores during its desorption.

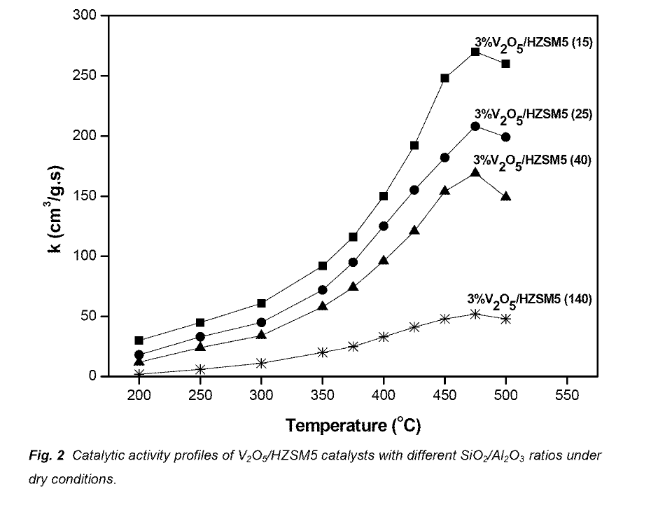

FIG. 2 shows the catalytic activity profiles of V₂O₅/HZSM5 catalysts with different SiO₂/Al₂O₃ ratios measured under dry conditions. Change in activity was observed for all the catalysts in the examined temperature range of 200-500° C., and the light-off temperature (i.e. the temperature at which the catalyst achieves a 50% conversion rate) for this series of catalysts was around 300° C. Maximum activity was observed at 475° C. and decreased thereafter with temperature. With an increased SiO₂/Al₂O₃ ratio of the support a decrease in catalytic activity was observed (270 vs 40 cm³/g·s when increasing SiO₂/Al₂O₃ ratio from 15 to 140) thus clearly demonstrating the relation between activity and the catalyst acidity. It is well known that the NO activity and the acidity of zeolite supports are connected, as also observed by Andersson and co-workers [L. A. H. Andersson et al., Catal. Today 4 (1989) 173] in their study on SCR of NO over acid-leached mordenite catalysts. With increasing SiO₂/Al₂O₃ ratio there will be a decrease in acidity of catalysts as observed in the TPD studies (vide supra). Additionally, the catalyst activity might also be affected by the nature and concentration of active vanadium species at exchange sites. With these observations other zeolite materials like HBETA, HY and HMORDENITE were selected with lower SiO₂/Al₂O₃ ratios 25, 12 and 10 respectively. The observed rate constant values are lower than those of reported catalysts. This might be due to a lower surface density of V₂O₅ on these high surface area support materials. Accordingly the V₂O₅ content was increased to 16 wt %.

FIG. 3 shows the catalytic activity profiles obtained on various alternative zeolites with different V₂O₅ content under dry conditions. With increasing V₂O₅ content the catalytic activity was found to increase up to a certain loading and thereafter decreased. This trend has also been seen in V₂O₅/TiO₂ systems due to formation of polymeric species that are more active than the monomeric species. Hence, a higher reactivity of polymeric metavanadate species compared to isolated vanadyls, as well as a faster reduction by NH₃ and a faster reoxidation by gaseous oxygen of the polymeric metavanadate groups was also reported.

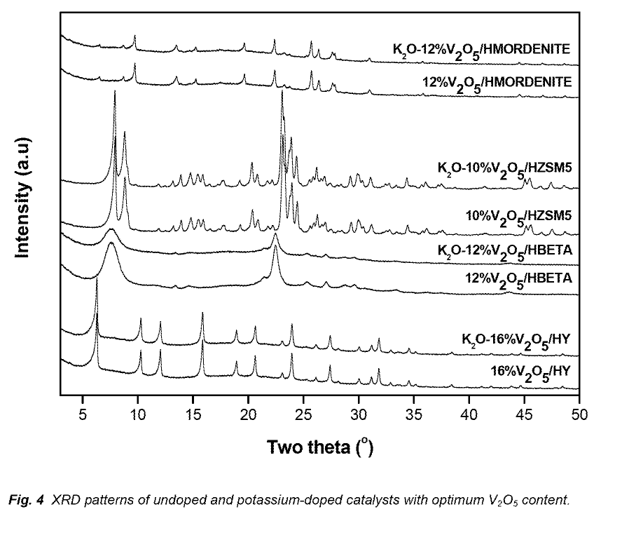

In all the alternative zeolite catalysts, no diffraction peak corresponding to crystalline V₂O₅ was observed (FIG. 4) and only pure support patterns were reflected in the XRD. Moreover, all catalysts were highly dispersed and well below the V₂O₅ monolayer surface coverage as seen from the surface density in Table 2. To achieve monolayer capacity a surface density of 8 μmol V₂O₅/m² is needed. Among all the examined supports 12% V₂O₅/HMORDENITE showed the highest catalytic activity followed by 10% V₂O₅/HZSM5, 12% V₂O₅/HBETA and 16% V₂O₅/HY. 12% V₂O₅/HMORDENITE catalysts showed a maximum rate constant value of 944 cm³/g·s, whereas 10% V₂O₅/HZSM5, 12% V₂O₅/HBETA and 16% V₂O₅/HY catalysts showed maximum rate constant values of 667, 394 and 376 cm³/g·s, respectively. All the optimum catalysts showed maximum catalytic activity at 460° C. except the 10% V₂O₅/HZSM5 catalyst, which showed maximum activity at 480° C. and the light-off temperature for this series of catalysts was around 300° C., as also found for the HZSM5 catalysts.

From the data compiled in Table 2, a unique relationship between the catalytic activity and the structure type, the textural or the acidity characteristics of the zeolite catalyst can be sought. The most direct parameter to be considered, namely the structural type, which determines the size of the micropores, can be considered relevant since HZSM5 and HMORDENITE catalysts with 0.1 and 0.13 cm³/g micropore volumes feature a higher activity than the HY and HBETA catalysts with corresponding micropore volumes of 0.24 and 0.19 cm³/g, respectively. Bartholomew et al. [I. Eng and C. H. Bartholomew, J. Catal. 171 (1997) 14; ibid., J. Catal. 171 (1997) 27] also preferred MORDENITE and ZSM5 catalysts over Y-zeolite for the SCR process due to enhanced formation of the 3H structure (i.e., NH₄⁺ triplet-combined through three hydrogen bonds with Al(OH)₃H⁻) by small pore zeolites. This structural characteristic is apparently associated with the formation of an active complex during SCR, which explain the high activity of HMORDENITE and HZSM5 as compared with Y zeolite.

The results of the NH₃-TPD are summarized in Table 2. The order of the acidity of the catalysts was: HBETA>HMORDENITE>HZSM5>HY and that of SCR activity was HMORDENITE>HZSM5>HBETA>HY. Clearly the HBETA catalyst was not following the expected trend; even though it had more acidic sites, its structural properties hampered the activity, thus signifying the importance of structure sensitivity of zeolites besides the acidic characteristics for SCR applications. Essentially all the catalysts showed a Tₘₐₓ1 peak at around 175 to 190° C., while the strongly acidic sites Tₘₐₓ2 peak was significantly enhanced to 410° C. for the HMORDENITE catalyst due to its high acid site density. Hence, both structural and acidic characteristics favoured the HMORDENITE catalysts in SCR compared to the other catalysts, in accordance with the activity measured.

TABLE 2
Surface area, pore volume and NH₃-TPD characterization results of
undoped and potassium-doped catalysts with optimum V₂O₅ content.

| | | Surface | | | | |
|---|---|---|---|---|---|---|
| | Surface | density | Micropore | Total | | |
| | area | (μmol | volume | Acidity | Tₘₐₓ1 | Tₘₐₓ2 |
| Catalyst | (m²/g) | V₂O₅/m²) | (cm³/g) | (μmol/g) | (° C.) | (° C.) |
| 16%V₂O₅/HY | 524 | 1.67 | 0.24 | 327 | 176 | 321 |
| 12%V₂O₅/HBETA | 510 | 1.43 | 0.19 | 571 | 184 | 339 |
| 10%V₂O₅/HZSM5 | 324 | 1.70 | 0.10 | 330 | 188 | 376 |
| 12%V₂O₅/HMORDENITE | 348 | 1.89 | 0.13 | 422 | 188 | 410 |
| K₂O—16%V₂O₅/HY | 488 | 1.80 | 0.23 | 267 | 171 | 318 |
| K₂O—12%V₂O₅/HBETA | 497 | 1.50 | 0.18 | 488 | 179 | 330 |
| K₂O—10%V₂O₅/HZSM5 | 298 | 1.85 | 0.09 | 302 | 184 | 370 |
| K₂O—12%V₂O₅/HMORDENITE | 322 | 2.05 | 0.12 | 396 | 177 | 396 |

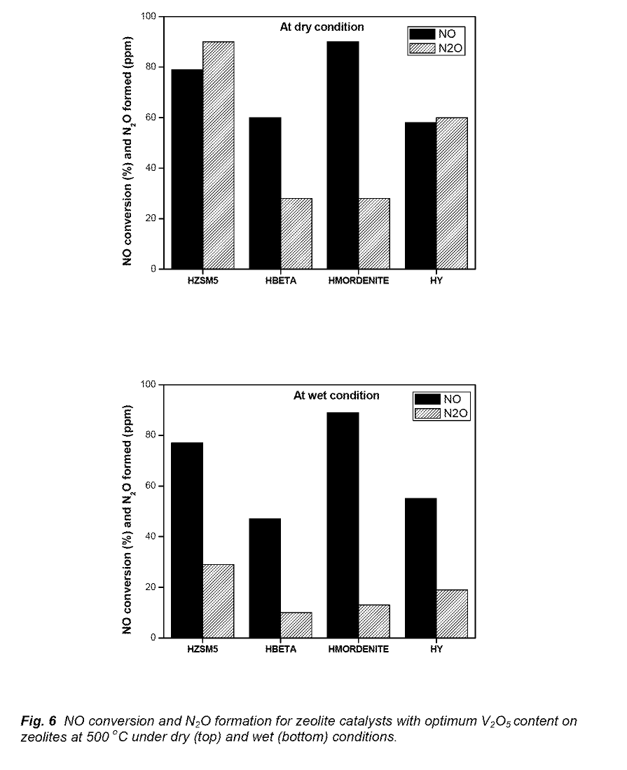

It is very important to study the influence of water on the performance of SCR catalysts since water most often is present in the flue gas. Most authors, with few exceptions, agree that water hamper the SCR reaction and has a mechanistic influence on the SCR activity. FIG. 5 shows the catalytic activity profiles obtained under wet conditions for the optimum zeolite catalysts. The light-off temperature for the optimum catalysts here shifted to around 350° C. compared to 300° C. under dry conditions. Among all the supports HMORDENITE showed the highest catalytic activity followed by HZSM5, HY and HBETA. Importantly, the catalytic activity of 12% V₂O₅/HMORDENITE (1052 cm³/g·s) catalyst was much higher than that of commercial V₂O₅—WO₃/TiO₂ catalyst activity (500 cm³/g·s) reported in the literature under similar reaction conditions. Moreover, maximum catalytic activity was shifted towards higher temperatures in the presence of water, thus clearly indicating an inhibition effect of water on the SCR reaction at low temperatures. This inhibition effect is probably a result of water adsorption on the catalyst surface at lower temperature. By increasing the reaction temperature, water can be expected to desorb from the pores of zeolites and thus circumvent the inhibition effect. On the other hand, the positive role of water being present was seen in terms of a significant decrease in N₂O formation on 12%V₂O₅/HMORDENITE catalyst at 500° C. cf. FIG. 6. The HMORDENITE catalyst showed high conversion and selectivity as compared to the other catalysts. Especially, HZSM5 and HY catalysts are forming relatively high amounts of N₂O. This clearly shows that the ammonia oxidation reaction, responsible for the N₂O formation was suppressed under wet conditions even at elevated temperatures.

The results of the N₂-BET surface area, surface density of V₂O₅, micropore volume and acidity measurements are summarized in Table 2 for potassium-doped catalysts. Upon the addition of potassium the surface area and pore volume slightly decreased, which can be the result of specific interaction of the potassium with the support material as well as partial physical blocking of the support pores. Total acidity of the potassium oxide doped catalysts also decreased slightly compared to the analogous undoped sample. Furthermore, the Tₘₐₓ1 and Tₘₐₓ2 positions of the potassium doped catalyst shifted with about 10° C. to lower temperatures, indicative of lower relative strengths of the acid sites. Assuming that potassium oxide first occupy the strongest acidic sites present on the support and then weakens the remaining acidic sites due to electron donation, the Tₘₐₓ should be expected to shift towards lower temperature region.

Doping the optimum catalysts with potassium (100 μmol/g) resulted in a slight decrease in activity and a small shift of maximum catalytic activity towards a lower temperature (FIG. 5). Especially the HMORDENITE catalyst showed increased resistance to the alkali poisoning and was deactivated by only 9% at 500° C., whereas the other catalysts with HZSM5, HY and HBETA support material were deactivated by 11%, 30% and 35%, respectively at their Tₘₐₓ temperatures. The observed change in catalytic activity after doping with potassium seemed to correlate well with the loss in total acidity of the catalysts (listed in Table 2). In general, high dispersion of vanadium, high surface area and high surface acidity of zeolites enable hosting of potassium oxide with relatively little change in total acidity. Consequently, the potassium deactivation was significantly lower in the present catalysts compared to that of traditional SCR catalysts. In traditional catalysts 45% deactivation has been observed on highly active V₂O₅—WOₓ/ZrO₂ catalyst with an even lower potassium concentration of 80 μmol/g [J. Due-Hansen et al., J. Catal. 251 (2007) 459]. The important deactivation resistance parameters for metal oxide support materials suggested by Due-Hansen et al. [J. Due-Hansen et al., supra] are low vanadium coverage (below one monolayer), high surface area, and high surface acidity. These three crucial parameters are all accommodated by the preferred HZSM5 and HMORDENITE zeolite catalysts of the present invention. For zeolite supports an additional structural parameter concerned with the size of micropores can also alter the SCR catalytic activity as also found in this study.

1. A method for selectively removing nitrogen oxides in the presence of ammonia from gases containing a significant amount of alkali metal and/or alkali earth compounds, which comprises exposing the gases to a catalyst comprising:
a. a zeolite support with a SiO₂/Al₂O₃ ratio lower than 40
b. 8% w/w or more V₂O₅
in the presence of a nitrogen containing compound selected from the group consisting of ammonia, ammonium salts, urea or a solid urea derivative.

2. The method according to claim 1 comprising 8-16%; w/w V₂O₅.

3. The method according to claim 1 wherein the zeolite has a SiO₂/Al₂O₃ ratio of between 10 and 25.

4. The method according to claim 1 wherein the zeolite is a selected member from the group consisting of HMORDENITE, HZSM5, HBETA and HY.

5. The method according to claim 1 wherein the selective removal of nitrogen oxides takes place in the presence of ammonia or urea and at a reaction temperature from about 320 to about 400° C.

6. A method for providing a zeolite catalyst, comprising the steps of:
a) calcining the ammonium form of a zeolite support at about 550° C. for about 5 hours to obtain the acidic, H-form of the zeolite,
b) impregnating the calcined zeolite support with a vanadia precursor,
c) drying the impregnated zeolite catalyst at about 120° C. for about 12 hours and thereafter calcining the zeolite catalyst at 500° C. about 4 hours.
wherein said zeolite support has a SiO₂/Al₂O₃ ratio lower than 40, and wherein said catalyst comprises 8% w/w V₂O₅ or more.

7. The catalyst obtained by the method according to claim 6.

8. The catalyst according to claim 7 containing between 9 and 14% V₂O₅

9. The catalyst according to claim 7 wherein the zeolite support is a member selected from the group consisting of HMORDENITE, HZSM5, HBETA and HY.

10. The catalyst according to claim 7 which comprises 12% V₂O₅ on an HMORDENITE support.

11. The catalyst according to claim 7 having a maximum rate constant value of over 600 cm³/g·s at between 460-480° C. and a light-off temperature around 300° C.

12. A method for the selective removal of nitrogen oxides with ammonia from gases resulting from the burning of biomass, combined biomass-fossil fuel, or emerging from waste incineration units comprising exposing the gases to the catalyst of claim 7 at a temperature from about 320 to about 400° C.

13. The catalyst according to claim 7 in the shape of a monolith, extrudate, bead, plate, sheet or fibrous cloth.

14. A process for the selective removal of nitrogen oxides with a nitrogen containing compound selected from ammonia, ammonium salts, urea or a solid urea derivative from gases resulting from the burning of biomass, combined biomass-fossil fuel, or emerging from stationary waste incineration units, which gases contain significant amounts of alkali metal and/or alkali earth compounds, which comprises exposing the gases to a catalyst according to claim 7.

15. A process according to claim 14 for the selective removal of nitrogen oxides from gases, wherein the gases contain significant amounts of moisture.

16. The method of claim 2 wherein the catalyst comprises between 9 and 14% w/w V₂O₅.

17. The method of claim 2 wherein the catalyst comprises between 10-12% of w/w V₂O₅.

18. The method of claim 2 wherein the catalyst comprises about 12% w/w V₂O₆.
